(19) United States
(12) Patent Application Publication
(10) Pub. No.: US 2015/0016375 A1
(43) Pub. Date: Jan. 15, 2015

(54) Control of Frequency Channel Between Wireless Access Points According to Sequence

(71) Applicants: Richard S. Davis, Salem, MA (US); John S. Balian, Westford, MA (US); Jung Gun Lee, Mountain View, CA (US); Sung-Ju Lee, Redwood City, CA (US); Raul Hernan Etkin, Sunnyvale, CA (US); Scott A. Lindsay, Providence, RI (US); Tom Hogan, Lutz, FL (US)

(72) Inventors: Richard S. Davis, Salem, MA (US); John S. Balian, Westford, MA (US); Jung Gun Lee, Mountain View, CA (US); Sung-Ju Lee, Redwood City, CA (US); Raul Hernan Etkin, Sunnyvale, CA (US); Scott A. Lindsay, Providence, RI (US); Tom Hogan, Lutz, FL (US)

(21) Appl. No.: 14/377,920

(22) PCT Filed: Feb. 29, 2012
(86) PCT No.: PCT/US2012/027113

§ 371 Date: Aug. 11, 2014

(51) Int. Cl. H04W 72/04; H04W 88/08

(52) U.S. Cl. CPC H04W 72/0453; H04W 88/08
USPC 370/329

(57) ABSTRACT

Embodiments herein relate to transferring control of a frequency channel between wireless access points (WAP) according to a sequence where the frequency channel is part of an industrial, scientific and medical (ISM) radio band. Each of the WAPs transfers control of the same frequency channel according to a sequence. The transfer of control in the sequence occurs between adjacent WAPs, and the first and last WAPs in the sequence are adjacent to each other.

### BACKGROUND

Wireless networks may operate on unlicensed bands, such as Wi-Fi. Wireless networks that use unlicensed bands may have lower costs than wireless networks that use licensed bands, such as cellular or WiMax networks. For example, deployment, maintenance and system costs of wireless networks using unlicensed bands may be lower than that of those using licensed bands.

However, wireless networks that use unlicensed bands and that are relatively large in size, may not operate effectively. For example, information may be lost and/or transmitted repeatedly in such large wireless networks due to contention and interference, as well as a lack of determinism. Manufacturers, vendors, and/or users are challenged to provide more effective methods for transmitting information over large wireless networks using unlicensed bands.

### BRIEF DESCRIPTION OF THE DRAWINGS

The following detailed description references the drawings, wherein:

FIG. 1 is an example block diagram of a wireless network including a plurality of wireless access points (WAP);

FIG. 2A is an example block diagram of a plurality of blocks including the WAPs of FIG. 1;

FIG. 2B is an example diagram of a block of FIG. 2A;

FIG. 2C is an example sequence for the block of FIG. 2B;

FIG. 20 is an example block diagram of first and last WAPs in the sequence of FIG. 2C;

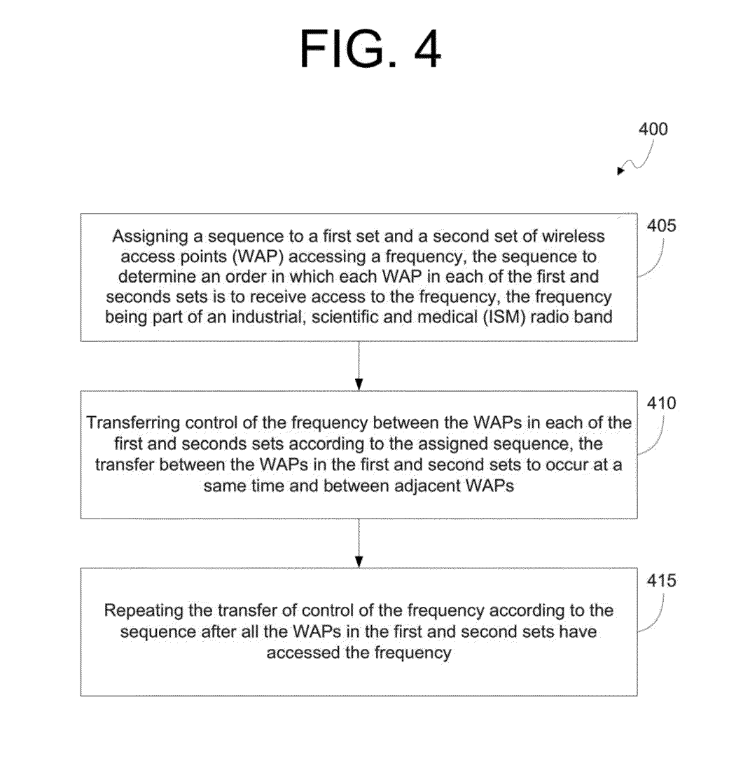

FIG. 3 is an example block diagram of a computing device including instructions for transferring control of a frequency channel between WAPs according to a sequence; and

FIG. 4 is an example flowchart of a method for transferring control of a frequency channel between WAPs according to a sequence.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Wireless networks may operate on unlicensed bands and use standards like Wi-Fi, in order to save costs, compared to operating on licensed bands. Also, an bands for licensing and/or exclusive use may not always be available in certain environments. In addition to avoiding licensing fees, wireless networks using unlicensed bands may also have lower deployment, maintenance and system costs.

Nonetheless, interference may become too great between network elements, such as wireless access points (WAP) or client devices (CD), using a same frequency channel of the unlicensed band in larger wireless networks. For example, a large wireless network, such as an oil and gas exploration system, may include thousands to millions of CDs, such as sensors, that send information to one or more WAPs over the same frequency channel. The one or more WAPs may forward the information to a central entity, such as a central command center. In this case, reliable delivery of the information may be difficult because of the interference between the CDs and/or WAPs attempting to communicate simultaneously over the same frequency channel. Further, if the CDs and/or WAPs are running on a limited power source, such as a battery, the power source may become drained more quickly, due to retransmissions of information lost to radio frequency (RF) interference. In addition, time may be wasted attempting to receive and/or transmit the information due to the RF interference.

Embodiments herein relate to transferring control of a frequency channel between wireless access points (WAP) according to a sequence where the frequency channel is part of an industrial, scientific and medical (ISM) radio band. For example, each of the WAPs sequentially transfers control of the same frequency channel according to the sequence. The transfer of control in the sequence occurs between adjacent WAPs, and the first and last WAPs in the sequence are adjacent to each other.

Embodiments may further include blocks, with each block including the plurality of WAPs. The WAPs of each block may follow the sequence, with at least two of the blocks sharing the same frequency channel, e.g. co-channel blocks. The co-channel blocks may be placed to maximize a distance therebetween to reduce RF interference. Further, the sequence may give each WAP of each block a fair chance to use the frequency channel while also reducing RF interference between both adjacent blocks and co-channel blocks. Further, power may be saved and information reception/transmission times may be reduced. Moreover, by using the ISM radio band, embodiments may be more readily deployed in different environments, such as different parts over the world, because the costs and restrictions inherent in securing a licensed band may not be present.

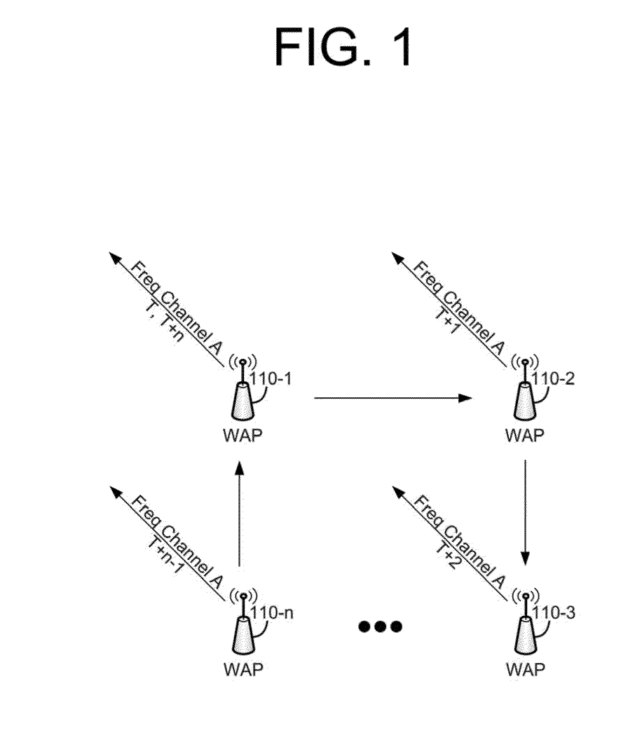

Referring to the drawings, FIG. 1 is an example block diagram of a wireless network 100 including a plurality of WAPs 110-1 to 110-n, where n is a natural number. The wireless network 100 may be any type of network using a transmission system including radio waves from an ISM radio band spectrum. The ISM radio band is generally used for unlicensed operations. Thus, the WAPs may, for example, be wireless LAN devices using one of the following frequency channels: 2450 MHz band (Bluetooth), 5800 MHz band (HIPERLAN), 2450 and 5800 MHz bands (IEEE 802.11/WiFi) and/or 915 and 2450 MHz bands (IEEE 802.15.4/ZigBee).

The plurality of WAPs 110-1 to 110-n share a same frequency channel that is part of the ISM radio band, such as one of the frequency channels listed above. Thus, the first WAP 110-1 uses a frequency channel usable by, for example, the second WAP 110-2. The term frequency channel may refer to a specific, pair and/or band of frequencies. For example, the frequency channel 2.450 Gigahertz (GHz) may refer to a center frequency of 2.450 GHz and a frequency range of 2.400 GHz to 2.500 GHz.

The WAPs 110-1 to 110-n may be any type of device that allows information collected from client devices (not shown) to be relayed to a remainder of the wireless network 100, such as a router, a switch, a gateway, a server, a command center and the like. The WAPs 110-1 to 110-n may include, for example. a hardware device including electronic circuitry for implementing the functionality described below, such as control logic and/or memory. In addition or as an alliterative, the WAPs 110-1 to 110-n may be implemented as a series of instructions encoded on a machine-readable storage medium and executable by a processor.

Each of the plurality of WAPs 110-1 to 110-n sequentially transfers control of the same frequency channel according to a sequence. For example, the first WAP 110-1 is to transfer control of the frequency channel to the second WAP 110-2 according to the sequence. The transfer of control in the sequence occurs between adjacent WAPs 110. The first and last WAPs 110-1 and 110-n in the sequence are also adjacent to each other.

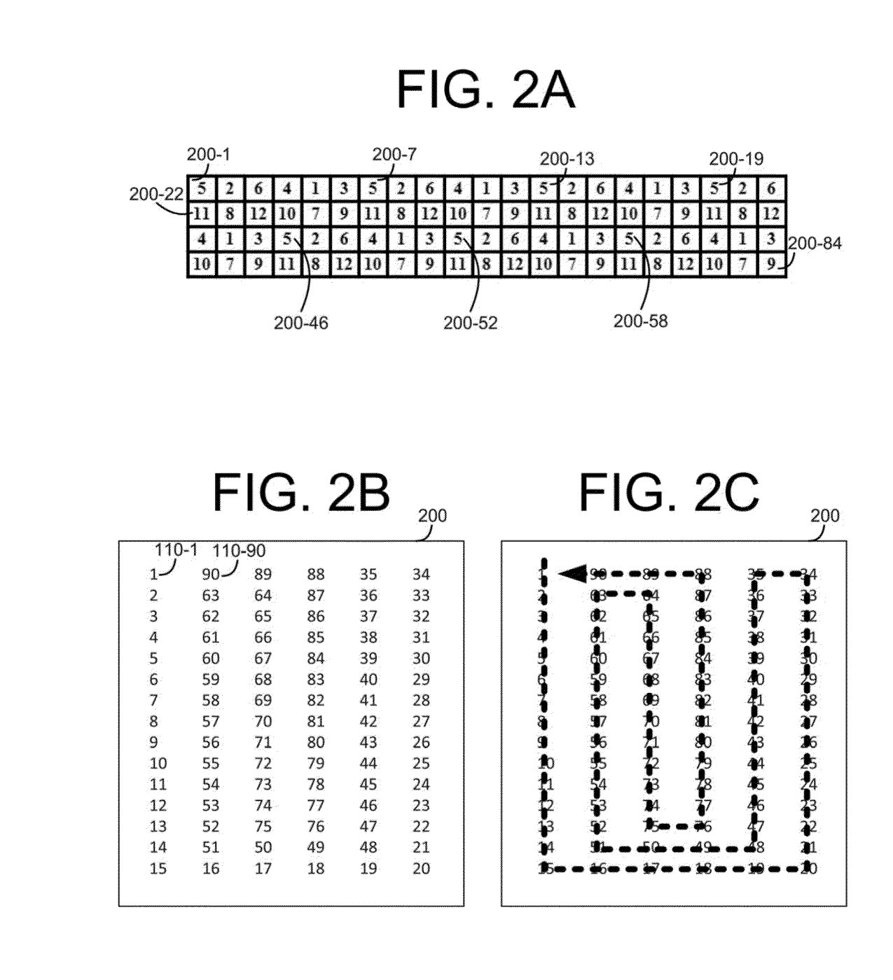

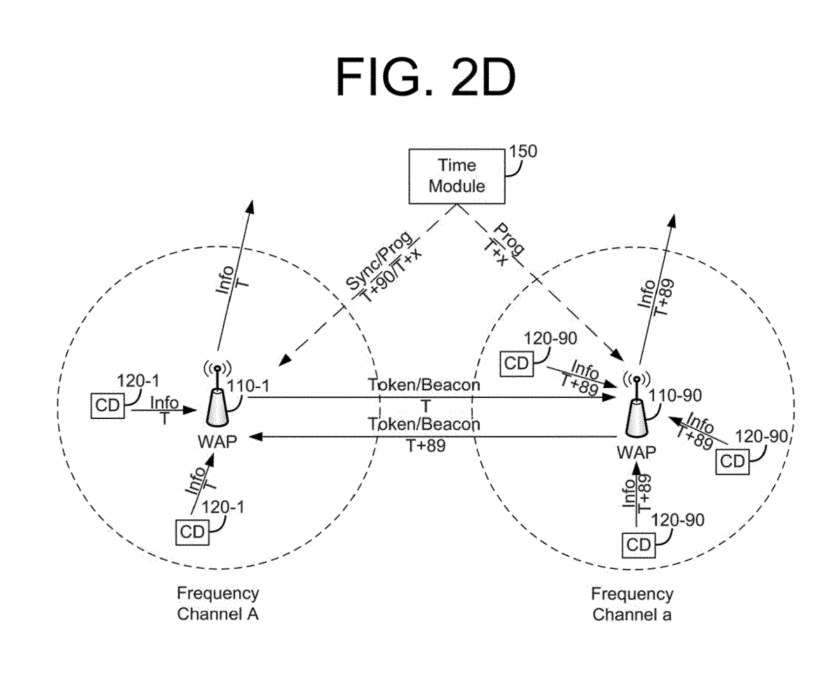

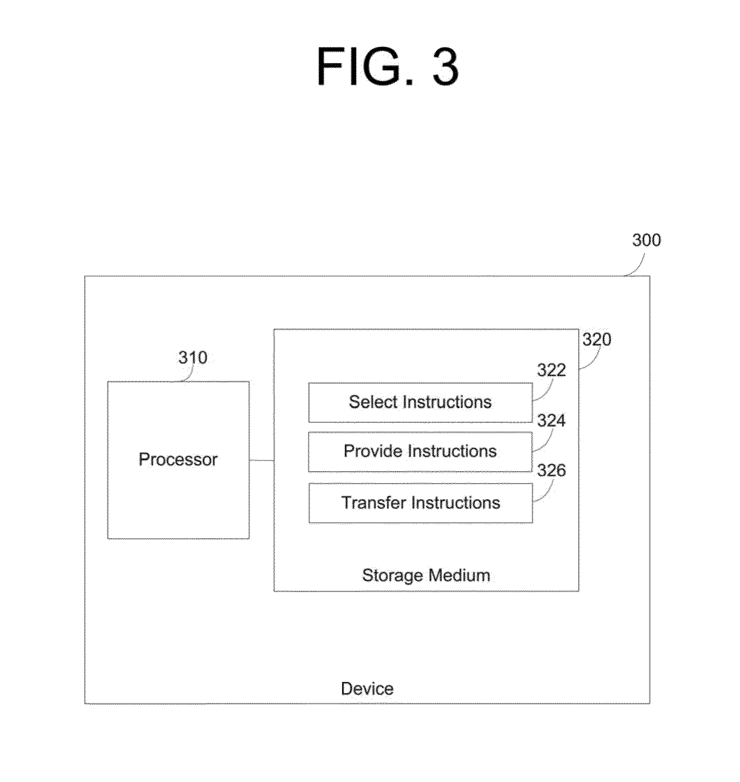

Thus, a current WAP 110 is adjacent to an other WAP 110 if the other WAP 110 is at least one of a next WAP 110 and an initial WAP 110 in the sequence. The current WAP 110 is a final WAP 110 of the sequence if the other WAP 110 is the initial WAP 110 in the sequence. For example, as shown in FIG. 1, a frequency channel A is used by the first WAP 110-1 at time T and the frequency channel A is used by the second WAP 110-2 at time T+1. This trend of passing control of the frequency channel A between adjacent WAPs 110 continues to the last WAP 110-n at time T+n−1. At this point, the cycle may continue to repeat and the first WAP 110-1 may again use the frequency channel A at time T+n. The sequence will be explained in greater detail with respect to FIGS. 2C-2D below.

FIG. 2A is an example block diagram of a plurality of blocks 200-1 to 200-84 including the WAPs 110 of FIG. 1. While FIG. 2A. show 84 blocks 200-1 to 200-84, embodiment may include more or less 84 blocks 200. Each of the blocks 200-1 to 200-84 may include the plurality of WAPs 110 of FIG. 1. Each of the blocks 200-1 to 200-84 uses one of a plurality of the frequency channels of the ISM radio band. A number shown in each block 200 may represent the frequency channel used by the WAPs 110 of that block 200.

In FIG. 2A, as there are only 12 frequency channels available and 84 blocks, the plurality of blocks 200-1 to 200-84 exceeds the plurality of frequency channels 1-12 available to the plurality of blocks 200-1 to 200-84. Thus, each of the frequency channels 1-12 is assigned to more than one of the blocks 200-1 to 200-84 and at least two of the blocks 200-1 to 200-84 use the same frequency channel. The frequency channels are assigned to maximize a distance between the at least two blocks 200 using the same frequency channel. For example, the first, seventh, thirteenth, nineteenth, forty-sixth, fifty-second and fifty-eighth blocks 200-1, 200-7, 200-13, 200-19, 200-46, 200-52 and 200-58 have all been assigned to use the frequency channel 5 but are also spaced so as a maximize a distance therebetween.

While FIG. 2A shows one type of arrangement for the frequency channels, embodiments are not limited thereto. Further, a size of each of the blocks 200-1 to 200-84 may be based on interference tolerance between at least two of the WAPs 100 of different blocks 200 sharing the same frequency channel. In one instance, a minimum distance between two blocks 200 sharing the same frequency channel, e.g. co-channel blocks, may be determined to be 7.8 kilometers (km) and a size of each of the blocks 200 may be at least 2×3 km, in order to maintain tolerable interference power levels.

FIG. 2B is an example diagram of a block 200 of FIG. 2A and FIG. 2C is an example sequence for the block of FIG. 2B. The block 200 may represent any one of the blocks 200-1 to 200-84 shown in FIG. 2A. In this case, the block 200 is shown to include 90 WAPs 110-1 to 110-90. The number of each WAP 110-1 to 110-90 represents an order of the WAP 110-1 to 110-90 in the sequence. For example, the first WAP 110-1 may be the first WAP 110 in the sequence to control the same frequency channel while the ninetieth WAP 110-90 may be last WAP 110 in the sequence to control the same frequency channel for a given cycle. The term cycle may refer a single completion of the sequence. The number of each WAP 110 may be determined according to a desired path of the sequence. After a cycle completes, a new cycle may begin again with the first WAP 110-1. As shown in FIGS. 2B and 2C, the first and last WAPs 110-1 and 110-90 of the sequence are adjacent to each other and a transfer of the same frequency channel occurs along adjacent WAPs 110.

Each of the plurality of blocks 200-1 to 200-84 may follow the same sequence shown in FIG. 2C. Thus, a path of the sequence may be designed to minimize interference between WAPs 110 of adjacent blocks 200, such as the first and twenty-second blocks 200-1 and 200-22, as well as co-channel blocks, such as the first and seventh blocks 200-1 and 200-7. Embodiments are not limited to the sequence shown in FIGS. 2B and 2C and may include a variety of different sequences. Further, the blocks 200-1 to 200-84 may follow different sequences and/or have different timing schemes for transitioning control of the frequency channel between WAPs 110. For example, the path of the sequence may be based on, a user's, administrator's or manufacturer's preference, a timing sequence, a location of the WAPs 110, distances of the WAPs 110 from a central point, MAC addresses of the WAPs and the like.

FIG. 2D is an example block diagram of the first and last WAPs 110-1 and 110-90 in the sequence of FIG. 2C. In the embodiment of FIG. 2D, the first WAP 110-1 of the block 200 transmits a beacon or token to indicate exclusive use of the same frequency channel when the first WAP 110-1 is in control of the same frequency channel during the time period T. During the time period T, a remainder of the plurality of WAPs 110 of the block 200, such as the ninetieth WAP 110-90 may not transmit information over the same frequency channel in response to hearing the beacon of the first WAP 110-1. Similarly, when another of the WAPs 110 of the block 200 is in control of the same frequency channel and transmitting the beacon or token, a remainder of the WAPs 110 of the block 200 do not transmit information over the same frequency channel. Thus, RF interference may be reduced by limiting use of the frequency channel to a single WAP 100 of the block 200 at a time.

The WAP 110, such as the first WAP 110-1, also transmits the beacon or token to signal to a next WAP 110, such as the second WAP 110-2, to prepare to receive control of the same frequency channel. Thus, adjacent WAPs 110 of the sequence may be physically proximate such that the beacon or token may be heard by the next WAP 110. The beacon or token may be a continuous or periodic radio signal with limited information content, such as an SSID, a channel number and security protocols such as WEP (Wired Equivalent Privacy) or WPA (Wi-Fi Protected Access).

As shown in FIG. 2D, a plurality of client devices (CD) 120-1 to 120-90 may transmit information to the plurality of WAPs 110-1 to 110-90. The CDs 120-1 to 120-n may include any type of device capable of measuring, collecting, storing and/or transmitting information to one of the WAPs 110-1 to 110-n, such as a sensor, a transmitter, and the like. For example, the block 200 may include 90 WAPs 110-1 to 110-90 and about 100 CDs 120 associated with each of the WAPs 110 110-1 to 110-90. Each WAP 110 and its associated one or more CDs 120 may be referred to as a cell (not shown). For example, the first WAP 110-1 and the first devices 120-1 may form a first cell while the ninetieth WAP 110-90 and the ninetieth devices 120-90 may form a ninetieth cell.

As noted above, the plurality of WAPs 110-1 to 110-90 share the frequency channel A, which is part of the ISM band. The frequency channel A is used, for example by the plurality of WAPs 110-1 to 110-90 to communicate with the plurality of CDs 120-1 to 120-90 and/or to each other. Each of the CDs 120-1 to 120-90 communicates with one of the WAPs 110-1 to 110-90 along the same frequency channel A when the WAP 110 is in exclusive control of the frequency channel A. For example, the first CDs 120-1 transmit information to the first WAP 110-1 using the frequency channel A during the time period T and the ninetieth CDs 120-90 transmit information to the ninetieth WAP 110-90 using the frequency channel A during the time period T+89.

Where there are a plurality of CDs 120 associated with one of the WAPs 110, the WAP 110 may poll all the associated CDs 120 for information in a sequential manner, e.g. not simultaneously, or contention based techniques, such as IEEE DCF or EDCA, in order to reduce or prevent or reduce RF interference. However, embodiments are not limited thereto and may also other methods for collecting information from the CDs 120. The first and second WAPs 110-1 and 110-90 may also forward or transmit the information to another WAP 110 and/or network entity (not shown), such as a higher level WAP, hub, router or gateway, during the respective time periods T and T+89.

The embodiment of FIG. 2D also includes a time module 150 to periodically transmit a sync command to the first WAP 110-1 and to transmit a program command to set a sequence number of at least one of the plurality of WAPs 110-1 to 110-90. The sync command may include a time to restart the sequence and/or start a new cycle. The sequence number provided by the program command to the WAP 110 may determine a position of the WAP 110 in the sequence. For example, the time module 150 may transmit the sync command at time T+90 after the last WAP 110-90 completes using the frequency channel A at time T+89. Further, the time module 150 may transmit the program command at any time T+x. where x is a natural number, but usually between cycles. Thus, the program command may be used to alter a path of the sequence, such as adding by a new WAP 110 to the sequence, removing an existing WAP 110 from the sequence and/or changing a position of a WAP 110 in the sequence, like by renumbering the first WAP 110-1 to be ninetieth in the sequence.

While FIG. 2D, shows a single time module 150 being used for the plurality of WAPs 110-1 to 110-90, embodiments may also include a plurality of time modules (not shown). For example, the plurality of time modules may have synchronized times. Each of the WAPs 110-1 and 110-90 and/or each of the blocks 200-1 to 200-84 may include one of the time modules and each of the time modules may sync a transition between the WAPs 110-1 to 110-90 in the sequences for each of the blocks 200-1 to 200-84. Further, the plurality of time modules may synchronize the sequences themselves of at least two blocks 200 using the same frequency channel, such as the first and seventh blocks 200-1 and 200-7.

The time module 150 may include, for example, a hardware device including electronic circuitry for implementing the functionality described above, such as a timer or GPS. In addition or as an alternative, the permission module 110 may be implemented as a series of instructions encoded on a machine-readable storage medium and executable by a processor.

FIG. 3 is an example block diagram of a computing device including instructions for transferring control of a frequency channel between the WAPs according to the sequence. In the embodiment of FIG. 3, the computing device 300 includes a processor 310 and a machine-readable storage medium 320. The machine-readable storage medium 320 further includes instructions 322, 324 and 326 for transferring control of a frequency channel between the WAPs (not shown) according to the sequence.

The computing device 300 may be, for example, a router, a switch, a gateway, a server, a command center or any other type of user device capable of executing the instructions 322, 324 and 326. In certain examples, the computing device 300 may included or be connected to additional components such as memories, sensors, displays, wireless access points (WAP), client devices (CD), etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322, 324 and 326 to implement for transferring control of a frequency channel between the WAPs according to the sequence. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic. magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for transferring control of a frequency channel between the WAPs according to the sequence.

Moreover, the instructions 322, 324 and 326 when executed by a processor (e.g., via one processing element or multiple processing elements of the processor) can cause the processor to perform processes, such as, the process of FIG. 4. For example, the select instructions 322 may be executed by the processor 310 to select one of a plurality of frequency channels of an ISM radio band for each of a plurality of blocks (not shown), each of the blocks including a plurality of WAPs. The provide instructions 324 may be executed by the processor 310 to provide exclusive access to the selected frequency channel of each block to a first WAP of the plurality of WAPs of each block.

The transfer instructions 326 may be executed by the processor 310 to transfer access to the frequency channel from the first WAP to a remainder of the WAPs for each block according to the sequence. The transfer of access occurs between adjacent WAPs for each of the blocks and the first WAP and a last WAP of the plurality of WAPs of the sequence for each of the blocks is adjacent. As noted above, the plurality of frequency channels is less than the plurality of blocks and the frequency channel of each block is selected to maximize a distance between the blocks having the same frequency channel.

FIG. 4 is an example flowchart of a method 400 for transferring control of a frequency channel between WAPs according to a sequence. Although execution of the method 400 is described below with reference to the wireless network 100, other suitable components for execution of the method 400 can be utilized. Additionally, the components for executing the method 400 may be spread among multiple devices. The method 400 may be implemented in the form of executable instructions stored on a machine-readable storage medium, such as storage medium 320, and/or in the form of electronic circuitry.

At block 405, the wireless network 100, such as a higher level network element (not shown), assigns a sequence to a first set and a second set of WAPs 110 accessing a frequency channel. The sequence determines an order in which each WAP 110 in each of the first and seconds sets is to receive access to the frequency channel, the frequency channel being part of an ISM radio band. Then, at block 410, the wireless network 100 transfers control of the frequency channel between the WAPs 110 in each of the first and seconds sets according to the assigned sequence. The transfer between the WAPs 110 in the first and second sets occur at a substantially same time and between adjacent WAPs 110. The transfer may be controlled in a distributed manner, such as by the individual WAPs 110 as described above with respect to the beacons, and/or a centralized manner. such as by a higher level network element transmitting control commands to the WAPs 110.

Next, at block 415, the wireless network 100 repeats the transfer of control of the frequency channel according to the sequence after all the WAPs 110 in the first and second sets have accessed the frequency channel. Only one of the WAPs 110 in each of the first and second sets controls the frequency channel at a given time. The controlling WAPs are to at least one of receive and transmit information from CDs. A distance between the first and second sets is based on tolerable interference powers of the WAPs 110. The sequence is based on maximizing distance between active WAPs in adjacent and co-channel blocks, where the active WAPs 110 are the WAPs 110 currently in control of the same frequency channel.

According to the foregoing, embodiments may provide a method and/or device for transferring control of a frequency channel between WAPs according to a sequence where the frequency channel is part of the ISM radio band. The sequence may give each WAP of each block a fair chance to use the frequency channel while also reducing RF interference between both adjacent blocks and co-channel blocks.

We claim:

1. A wireless network, comprising:
a first wireless access point (WAP) using a frequency channel usable by a second WAP that is part of an industrial, scientific and medical (ISM) radio band, wherein
the first WAP is to transfer control of the frequency channel to the second WAP according to a sequence,
the first WAP is adjacent to the second WAP if the second WAP is at least one of a next WAP and an initial WAP in the sequence, and
the first WAP is a final WAP of the sequence if the second WAP is the initial WAP in the sequence.

2. The wireless network of claim 1, wherein,
the first WAP is to transmit a beacon to indicate exclusive use of the same frequency channel when the first WAP is currently in control of the same frequency channel, and
the second WAP does not transmit information over the frequency channel when the first WAP is in control of the same frequency channel.

3. The wireless network of claim 2, wherein the first WAP is to transmit at least one of the beacon and a token to signal to the second WAP to prepare to receive control of the frequency channel.

4. The wireless network of claim 1, further comprising:
a time module to periodically transmit a sync command to the first WAP and to program a sequence number of at least one of the first and second WAPs. wherein
the sync command includes a time to restart the sequence, and
the sequence number of the WAP determines a position of the WAP in the sequence.

5. A wireless system, comprising:
a plurality of blocks, each of the blocks including a plurality of WAPs, the plurality of WAPs including the first and second WAPs of claim 1, wherein
each of the blocks uses one of a plurality of the frequency channels of the ISM radio band,
at least two of the blocks use a same frequency channel, and
the frequency channels are assigned to maximize a distance between the at least two blocks using the same frequency channel.

6. The system of claim 5, wherein,
each of the plurality of blocks follows the sequence, and
a path of the sequence is designed to minimize interference between WAPs of adjacent blocks.

7. The system of claim 6, further comprising:
a plurality of time modules to have synchronized times, wherein
at least one of each of the WAPs and each of the blocks includes one of the time modules, and
each of the time modules is to sync a transition between WAPs in the sequences.

8. The system of claim 6, wherein the time modules are to synchronize the sequences of the at least two blocks using the same frequency channel.

9. The system of claim 5, wherein,
the plurality of blocks exceeds the plurality of frequency channels available to the plurality of blocks, and
a size of each of the blocks is based on interference tolerance between two of the WAPs sharing the same frequency channel.

10. The system of claim 5, wherein further comprising:
a plurality of client devices (CD) to transmit information to the plurality of WAPs, wherein
at least one of the blocks includes a plurality of cells, each of the cells including one of the WAPs and at least one of the plurality of CDs, and
the at least one CD and the WAP included in each cell are to communicate when the WAP is in exclusive control of the same frequency channel.

11. A method, comprising:
assigning a sequence to a first set and a second set of wireless access points (WAP) accessing a frequency channel, the sequence to determine an order in which each WAP in each of the first and seconds sets is to receive access to the frequency channel, the frequency channel being part of an industrial, scientific and medical (ISM) radio band;
transferring control of the frequency channel between the WAPs in each of the first and seconds sets according to the assigned sequence, the transfer between the WAPs in the first and second sets to occur at a substantially same time and between adjacent WAPs; and
repeating the transfer of control of the frequency channel according to the sequence after all the WAPs in the first and second sets have accessed the frequency channel.

12. The method of claim 11, wherein,
only one of the WAPs in each of the first and second sets controls the frequency channel at a given time, and
the controlling WAPs are to at least one of receive and transmit information from client devices.

13. The method of claim 12, wherein,
a distance between the first and second sets is based on tolerable interference powers of the WAPs, and
the sequence is based on maximizing distance between active WAPs in adjacent and co-channel blocks, the active WAPs having control of the same frequency channel.

14. A non-transitory computer-readable storage medium storing instructions that, iF executed by a processor of a device, cause the processor to:
select one of a plurality of frequency channels of an industrial, scientific and medical (ISM) radio band for each of a plurality of blocks, each of the blocks including a plurality of wireless access points (WAP);
provide exclusive access to the selected frequency channel of each block to a first WAP of each block; and
transfer access to the frequency channel from the first WAP to a remainder of the WAPs for each block according to a sequence, wherein
the transfer of access occurs between adjacent WAPs for each of the blocks, and
the first WAP and a last WAP of the plurality of WAPs of the sequence for each of the blocks is adjacent.

15. The non-transitory computer-readable storage medium of claim 14, wherein
the plurality of frequency channels is less than the plurality of blocks, and
the frequency channel of each block is selected to maximize a distance between the blocks having the same frequency channel.
